(19) United States
(12) Patent Application Publication
(10) Pub. No.: US 2003/0222165 A1
(43) Pub. Date: Dec. 4, 2003

(54) Method and apparatus for exposing and editing VCR tapes contained within cassettes

(76) Inventors: Paul Michael Beckerle, St. Louis, MO (US); John M. Charnecki, Eureka, MO (US); Raymond E. Ragland, Maryland Heights, MO (US)

Correspondence Address: THOMPSON COBURN, LLP, ONE US BANK PLAZA, SUITE 3500, ST LOUIS, MO, 63101, US

(21) Appl. No.: 10/161,135

(22) Filed: May 30, 2002

(51) Int. Cl. G11B 23/087

(52) U.S. Cl. 242/341

(57) ABSTRACT

A fixture for receiving a videotape cassette has a pair of mechanical releases for engaging and operating the mechanical interlocks inhibiting the free access to the videotape contained within therein, thereby exposing a section of videotape and permitting the editing of the tape after being permanently installed within a cassette. A tab having a relatively narrow stem portion and relatively wider base portion includes a releasable dollop of adhesive or double sided adhesive carrier near the stem end and is used in the following method. A new start position for a videotape may be conveniently fixed to eliminate from viewing the otherwise annoying leader material by adhering the tab to the new start position until the tape clears any interfering tension roller, self peeling the tab leaving the exposed adhesive by advancing the tape into the cassette, and wrapping the tape around itself on the wind up spool to adhere two layers of tape together and thereby define the new start position.

### BACKGROUND AND SUMMARY OF THE INVENTION

With the advent of Video Cassette Recorders (VCR) and Video Cassette Players (VCP), and the phenomenal acceptance and widespread adoption and use at many levels of our society including consumer and business use, the making and selling of pre-recorded videotapes has proliferated. At the time of the writing of this patent, there are literally billions of pre-recorded videotapes in the possession and daily use by millions of consumers and businesses. While this technology was first vigorously contested in the courts by the motion picture industry, worried that it would eviscerate the commercial viability of the motion picture theater business, it has been enthusiastically embraced after the courts determined that it did not violate the law and it was discovered that many consumers still were willing to pay for the theater viewing of new movie releases and at the same time pay something to own a copy of the movie as well for viewing it at home with a VCR. “Hollywood” has turned this consumer preference to its advantage by adding video tape sales into the marketing strategy for commercializing a film. It has done so in several different ways, one of which has been to sell popular films on pre-recorded videotape to consumers, usually after a “first run” through the traditional theater circuit, and a “second run” through premium cable TV and satellite TV offerings. This has been met with great acceptance at the consumer level, and the result has been that many homes now own multiple VCRs and VCPs, and literally tens of pre-recorded video cassettes containing movies for all age brackets including children.

Not to miss a bet, “Hollywood” has also found a way to increase its return or leverage from this market by including a leader before the start of each pre-recorded tape containing a variety of promotional and advertising materials. Examples of these include simple product commercials, previews of coming attractions for upcoming theatrical release, and even an FBI warning cautioning against pirating of the pre-recorded materials through unauthorized copying. While some of this “leader” material can be interesting to a viewer the first several times that he views the tape, it usually doesn't take long until the viewer tires of it or it goes out of date and is no longer accurate in portraying the upcoming release of a movie that has already been released and not too long thereafter has even passed out of release. Other portions of this leader material are never thought to be worth watching, such as simple product commercials or the FBI warning. Nevertheless, each and every time a consumer loads the cassette tape into his player, he is forced to either sit through the leader or fast forward through it before he reaches his desired program. Further complicating the problem is the ever-increasing but otherwise random length of these leaders, thereby making it impossible to fast forward a consistent length of tape or time. While this process is not life threatening, it becomes an annoyance and requires a preliminary activity by an adult before a child's program is ready for viewing. Frequently, children are not patient and can be loud or disruptive while waiting for the adult to start the desired program from the pre-recorded cassette. Furthermore, the presence of the leader can confuse a child if he is permitted to operate the VCR by himself, perhaps not being able to read the label and not remembering which leader presages which program, thereby ending up with the wrong program material discovered only after viewing the leader material, and thus facing the viewing of another leader. This can result in unhappy children who must suffer a delay of their otherwise accustomed instant gratification.

There is thus a long felt need for a device and method for eliminating the problem of dealing with this leader material, either by viewing it or fast forwarding through it. However, for perhaps other good reasons, the construction of these cassettes has hindered the development of such a solution. One such construction feature is the mechanical interlocking that has been incorporated into these cassettes which limit the free access to the videotape contained within. These mechanical interlocks have been added to prevent someone from readily opening the cassette, either for copying it or to prevent inquisitive people from unintentionally ruining a tape. Typically, there are two mechanical interlocks, one to prevent the cover from being lifted to directly expose a length of tape, and a second to lock together sprockets forming part of the take up spools to prevent the tape from being advanced so as to be drawn out of the cassette. While these two mechanical interlocks are relatively easily accessible, they do require more than just a single pair of hands to operate together and are effective in keeping all but the determined from “messing up” the tape. This is also of importance as a “messed up” tape can quickly become entangled within a VCR or VCP and force the consumer to seek repair by a professional. These days, with the ever declining price of VCRs and VCPs, repair has become almost economically non-viable. Simple replacement with a new device has become more cost effective. Thus, these two mechanical interlocks prevent un-wary consumers from creating a real problem for themselves and help maintain an acceptable level of satisfaction with VCR usage. However, these mechanical interlocks also present a hurdle to anyone wanting to access the tape within the cassette as would be necessary to resolve the “leader” problem described herein. They also restrict a consumer from taking any other action with respect to the tape, such as possibly re-attaching a tape end to a take up spool in order to save the cassette from being discarded and replaced, or other similar reasonably simple adjustments as would enhance the use of these cassettes.

Still another problem presented by these cassettes is the plastic “welded” construction limiting ready access to their interior without breaking them open and then being faced with having to re-weld them shut, as well as the tension rollers hidden within the cassette. While one could gain access to the tension rollers by breaking open the cassette, a typical consumer really has no convenient way to re-weld or re-assemble the cassette. Thus, a consumer is left with the mystery of how many tension rollers there are inside the cassette which can be solved by sacrificing one such cassette. However, even upon learning the number of these rollers, their placement, and their orientation for contacting the respective sides of the tape, a consumer is then stymied with the problem of advancing anything past them to reach the take up spools. Consequently, the consumer is confronted with a significant number of barriers to making any adjustment to any pre-recorded tape.

In order to solve these and other problems, the inventors herein have developed a method and apparatus for not only accessing an exposed portion of tape and freeing up the tape to allow it to be readily withdrawn from the cassette, but also editing the tape to eliminate viewing of the leader so that the desired programming is positioned for immediate display. In simple terms, the invention includes a fixture of clam shell design that receives a videotape cassette on one side thereof. Included in the fixture is a pin type extension that engages the spool release typically found in videotape cassettes, as the clam shell fixture is closed. Also, a trigger with a chamfered tip on one side is positioned to engage the spring loaded cover hinge and hold it open as the clam shell fixture is closed. Lastly, a cover latch engages between the two sides of the fixture to releasably hold the fixture together about the cassette. Thus, using the fixture of the present invention, a videotape cassette will have its tape released and exposed upon being placed in the fixture and the fixture being closed about it. In this condition, the tape may be readily unwound from either or both spools and even completely withdrawn from within the cassette. This allows for unrestricted editing of the tape along the entirety of its length, among other things. Of course, care must be taken in handling the tape to prevent its becoming damaged. However, the fixture of the present invention does allow unrestricted access to a consumer without breaking open the cassette. For convenience, an advancing handle is positioned to engage one of the drive spools so that the tape may be readily advanced within the cassette, which is very convenient for use in adjusting the start position of the tape, as will now be explained.

Once the new starting position is determined by playing the tape to reach that position, the cassette may then be placed within the fixture to gain access to that newly desired starting position. A novel paper tab is then adhered to that position on the tape with a dollop of adhesive, the tab having a relatively thin stem extending out to a wider base. The tape is then advanced into the cassette with the handle, drawing the stem portion of the tab into the cassette, until the adhesive goes past the tension rollers. At that point, the base comes into contact with the cassette housing so that further advance of the tape peels the stem away from the adhesive, leaving it exposed on one side of the tape. The tab may be lifted out and discarded or merely fall away. As the tape is continued to be advanced and wound around the take up spool, the tape wraps around the exposed adhesive and adheres to it a second time. For security, the user may choose to continue to advance the tape to put pressure on the overlapping tape layers to ensure that the adhesive reliably adheres. This then completes the method. In subsequent use, the tape may no longer be rewound past its new start point and the leader material remains permanently wound around the take up spool, thankfully screened from any subsequent viewing.

While the principal advantages and features of the invention have been briefly described above, a fuller understanding may be gained by reading the more detailed description which follows.

### BRIEF DESCRIPTION OF THE DRAWINGS

FIG. 1a is a front view of a typical videocassette from the prior art with the cover hinged open to expose a length of the tape;

FIG. 1b is a side view of the videocassette shown in FIG. 1a depicting the hinged cover partially open;

FIG. 1c is a cross-sectional view from the bottom of the videocassette shown in FIG. 1a depicting the internal take up spools;

FIG. 2 is a top view of a tab of the present invention depicting the relative widths of the stem portion and the base portion;

FIG. 3a is a perspective view of the materials and their arrangement for manufacture of the tab of FIG. 2;

FIG. 3b is a side view of the raw materials and their passing through a processor for manufacture of the tab of FIG. 2;

FIG. 4 is an exploded view of the fixture of the present invention depicting both sides and their hinged connection in clam shell fashion;

FIG. 4a is an enlarged view taken from inside the fixture depicting the drive handle and its engagement of the cassette take up spool;

FIG. 4b is an enlarged view of the trigger release for the mechanical interlock holding the cassette cover in place;

FIG. 4c is an enlarged view of fixture latch for holding both sides of the fixture together;

FIGS. 5a-d are end views depicting the various positions of the fixture as it is closed about a cassette and engages both of the cassette mechanical interlocks;

FIG. 6 is a front view of the cassette with a tab positioned for adhering to the exposed tape;

FIG. 7 is a perspective view of a cassette within the fixture, and the cover hinged open to expose the tape;

FIG. 7a 1-3 are front, bottom and perspective views respectively depicting the tab adhered to the exposed tape as the cassette is contained within the fixture;

FIG. 7b 1-3 are front, bottom and perspective views respectively depicting the tab adhered and the tape after it has been advanced into the cassette;

FIG. 7c 1-3 are front, bottom and perspective views respectively depicting the tab adhered and the tape advanced past the first interior roller in the cassette;

FIG. 7d 1-3 are front, bottom and perspective views respectively depicting the tab adhered and the tape advanced past the second interior roller, with the tab base mechanically interfering with the cassette and the tab stem partially separating from the adhesive;

FIG. 7e 1-3 are front, bottom and perspective views respectively depicting the tab separated from the tape as the tape has advanced past the second interior roller and onto the take up spool;

FIG. 7f 1-3 are front, bottom and perspective views respectively depicting the tab separated, and an overlying wrap of tape coming into contact with the adhesive for attaching these two overlying layers of tape together; and

FIGS. 8 a&b are side views depicting different constructions of tabs and their respective adhesive deposits in use.

### DETAILED DESCRIPTION OF THE PREFERRED EMBODIMENT

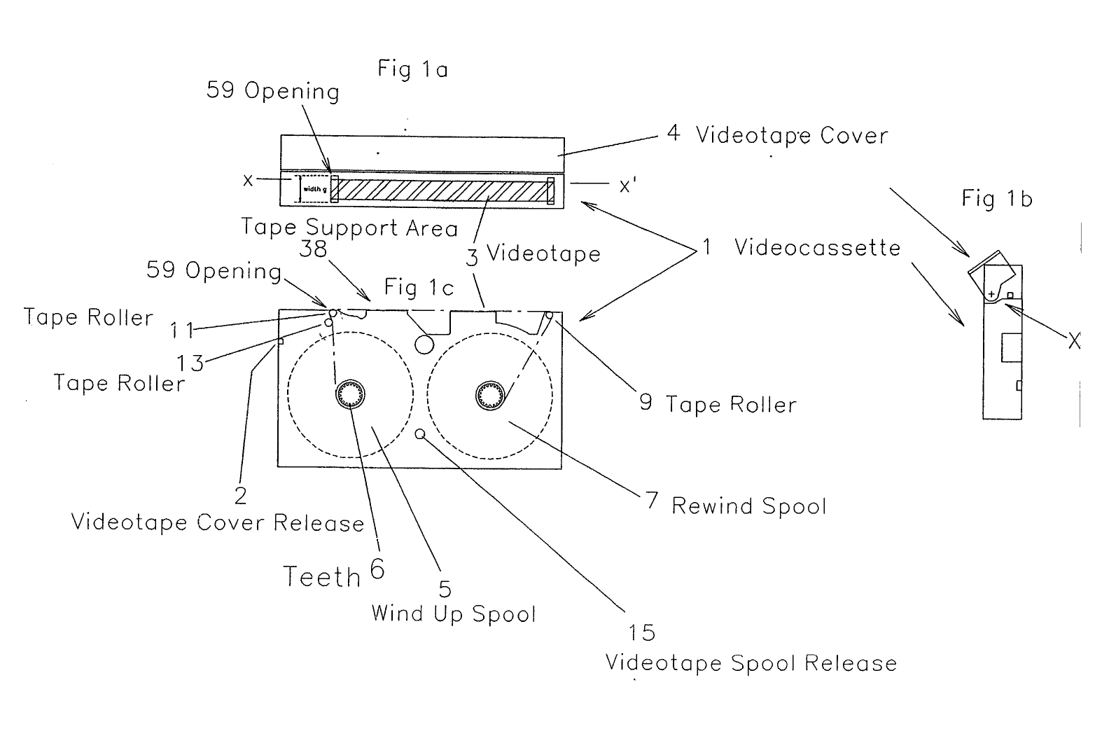

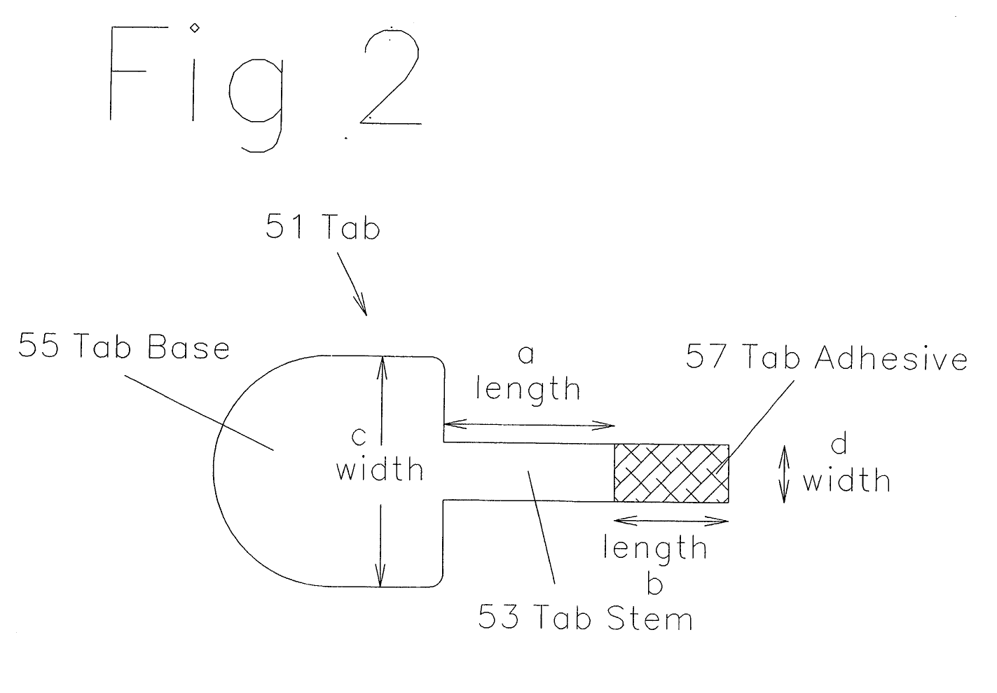

As shown in FIGS. 1a-c, a typical prior art videocassette 1 contains a videotape 3 wound at least partially around internal tension rollers 11, 13 and attached at its ends to a wind up spool 5 and rewind spool 7, both of which are referred to herein as spools or take up spools for convenience. These spools cannot be advanced or rewound without release of spool mechanical interlock 15 (the details of which are not shown but which are well known in the prior art). When the videotape is fully rewound, it is wrapped around rewind spool 7. As the tape is played, it is guided from rewind spool 7 past tension roller 9, across the front of cassette 1, between tension rollers 11, 13, and then onto wind up spool 5. A cover 4 is hinged to the cassette 1 and covers a tape support area 38 where a length of tape 3 is exposed upon cover 4 being hinged open. Cover 4 is mechanically interlocked against opening by a spring loaded cover interlock 2 (the internal details of which are not shown as being well known to those of ordinary skill in the art). This is the construction of most videotapes existing in the prior art and containing pre-recorded videotapes of the VHS variety.

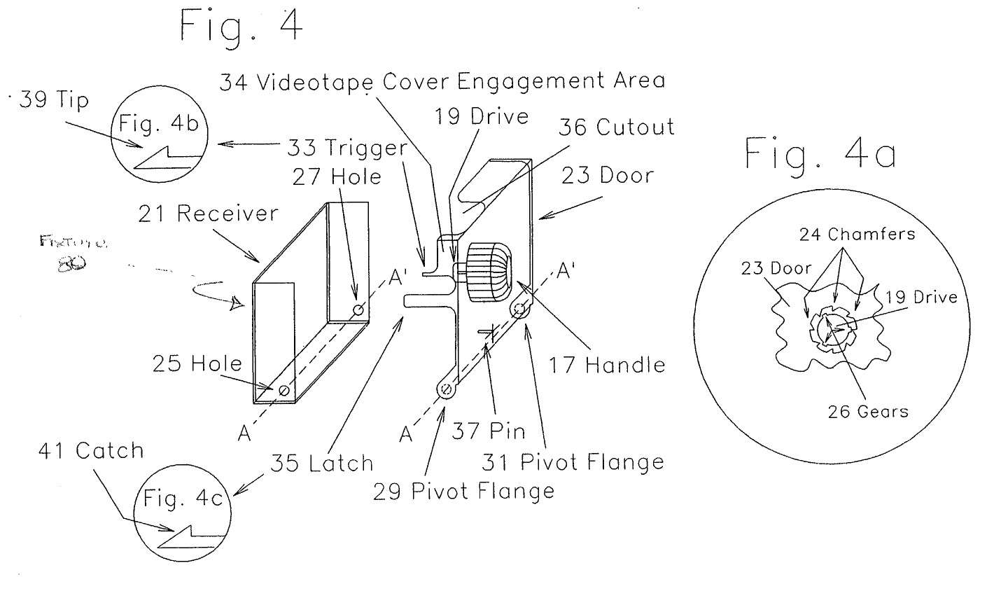

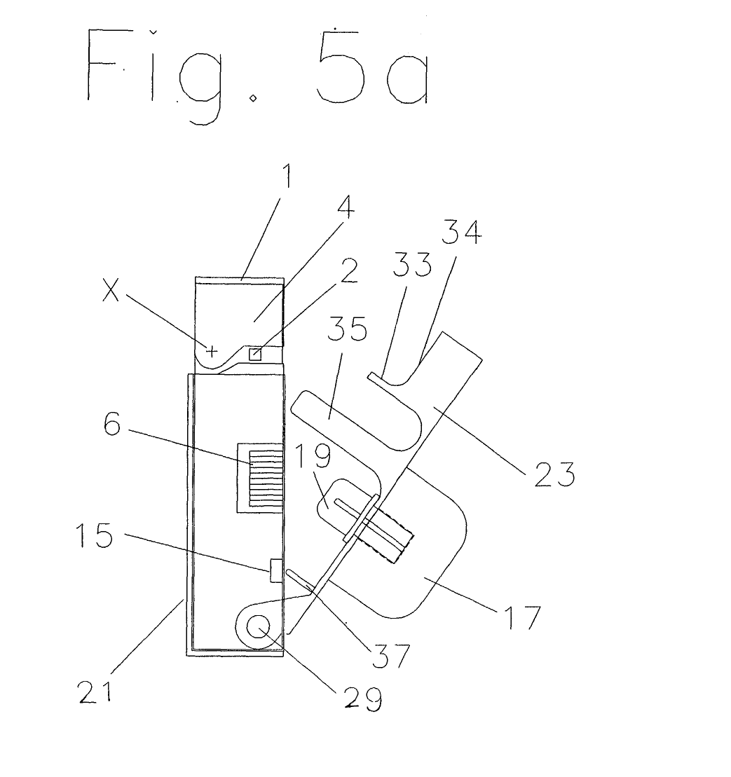

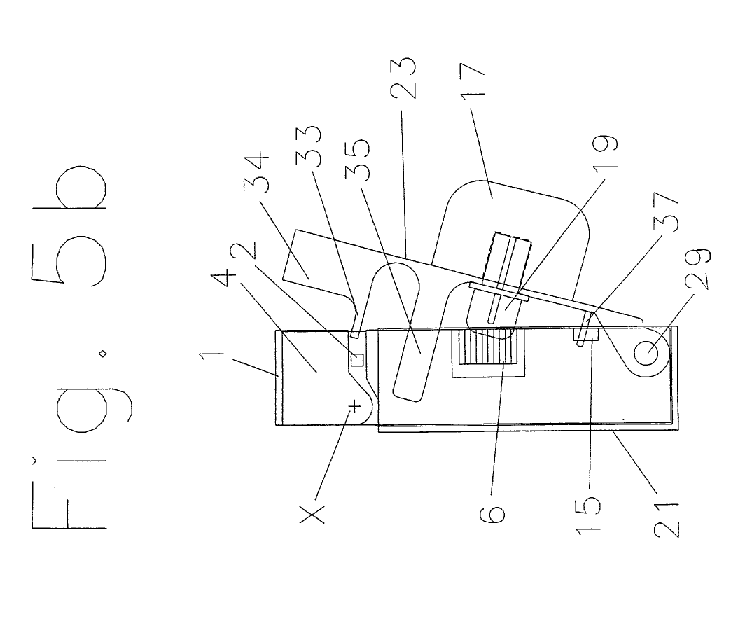

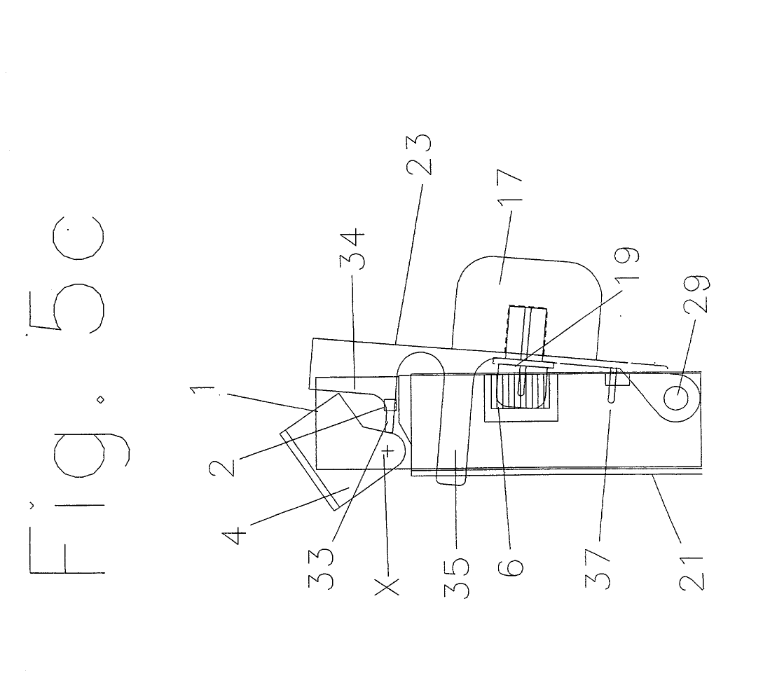

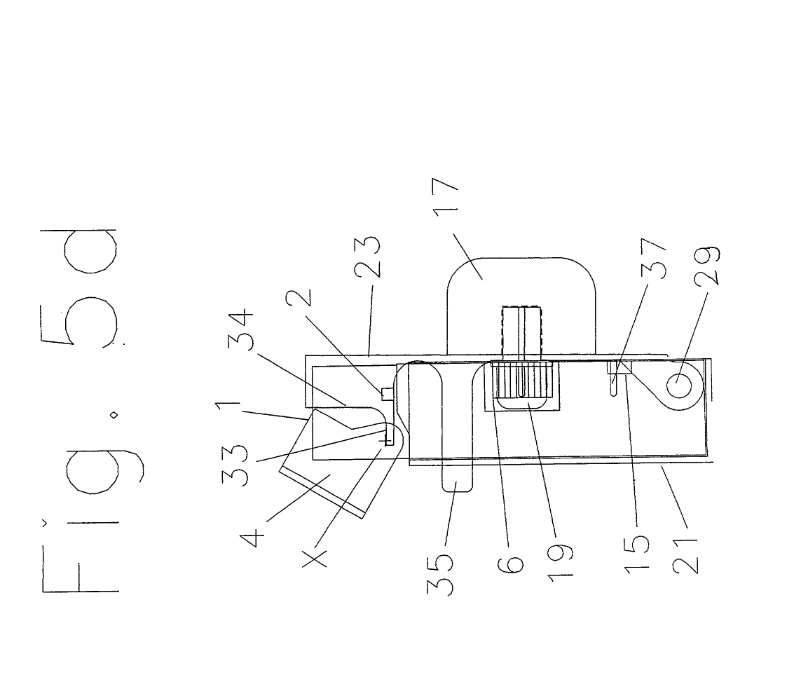

Turning now to FIG. 4, the novel fixture 80 comprises a receiver portion 21 and a door portion 23 which are joined in clam shell fashion by pivot flanges 29, 31 and holes 25, 27. The door portion 23 has a cutout area 36 where the exposed tape is accessible as the hinged cover 4 is pivoted away from the cassette. The fixture includes a latch 35 having a catch 41 for releasably securing the receiver portion 21 to the door portion 23 as the cassette is contained therein, thereby freeing the user's hands to work with the tape 3 and edit as described in greater detail below. The fixture includes two mechanical releases. The first of these comprises pin 37 for engaging the spool interlock 15 and releasing the spools 5, 7 as is explained in greater below. The second release comprises trigger 33 with tip 39 for engaging the cover interlock 2 first and then swinging open the cover 4 itself. Trigger 33 preferably flexes sufficiently to allow the chamfered tip 39 to advance past the hinge area of cover 4 to thereby hold the cover 4 open as the fixture is closed. A handle 17 with drive 19 are positioned on door portion 23 to engage the wind up spool 5 and permit a user to wind it in the counter clockwise direction. Preferably the handle/drive does not provide for rotation in the clockwise direction as rotation in that direction is not a direction which pulls the tape from the other spool 7, thereby creating the possibility for jamming or fouling the tape in the cassette or creating an easily damaged unsupported loop of tape 3 out of the cassette. Drive 19 preferably has gears 26 for engaging chamfers 24 and driving the wind up spool 5. The fixture 80, and all of its components, are preferably made of a rigid material such as ABS plastic or other material with similar strength and flexibility.

Operation of fixture 80 is best shown in the progressive different views comprising FIG. 5 a-d. The cassette is placed in receiver portion 21 and door portion 23 is then closed onto it in clam shell fashion. FIG. 5a shows the cassette first placed in receiver portion 21. FIG. 5b shows release pin 37 beginning to engage spool interlock 15, drive 19 beginning to engage teeth 6 of wind up spool 5, and trigger 33 beginning to engage cover interlock 2. Latch 35 is also now flexing open to allow it to pass around receiver portion 21. FIG. 5c shows release pin 37 nearly entirely home in engagement with spool interlock 15, drive 19 nearly fully engaged with teeth 6 of wind up spool 5, and trigger 33 has now passed by and depressed cover interlock 2 as well as beginning to open up hinged cover 4. Finally, in FIG. 5d, latch 35 has been engaged with the opposite side of receiver 21 to releasably lock the clam shell fixture closed, and the various mechanical releases have engaged their corresponding mechanical interlocks to thereby provide free access to a portion of the videotape 3 at tape support 38. Thus, a fixture 80 and its method of use are disclosed and described providing the automatic operation of mechanical interlocks on a videotape cassette allowing for the free access to a portion of the videotape, with the videotape being not only exposed but also freely movable about the take up spools. Alternatively, as is apparent from reading the foregoing description, the fixture 80 may not have a corresponding receiver portion 21 and instead the door portion 23 need only be used as it contains all of the operable portions of the fixture 80. In use, the door portion 23 would be engaged to the videotape merely be bringing it into contact with it, and then held in position during use. It should be understood that the preferred embodiment depicts videotape cassettes. However, other kinds of closed cassettes could also be operated in connection with this or a similar fixture to allow not only for changing of the start position, but also editing of the tape contained therewithin.

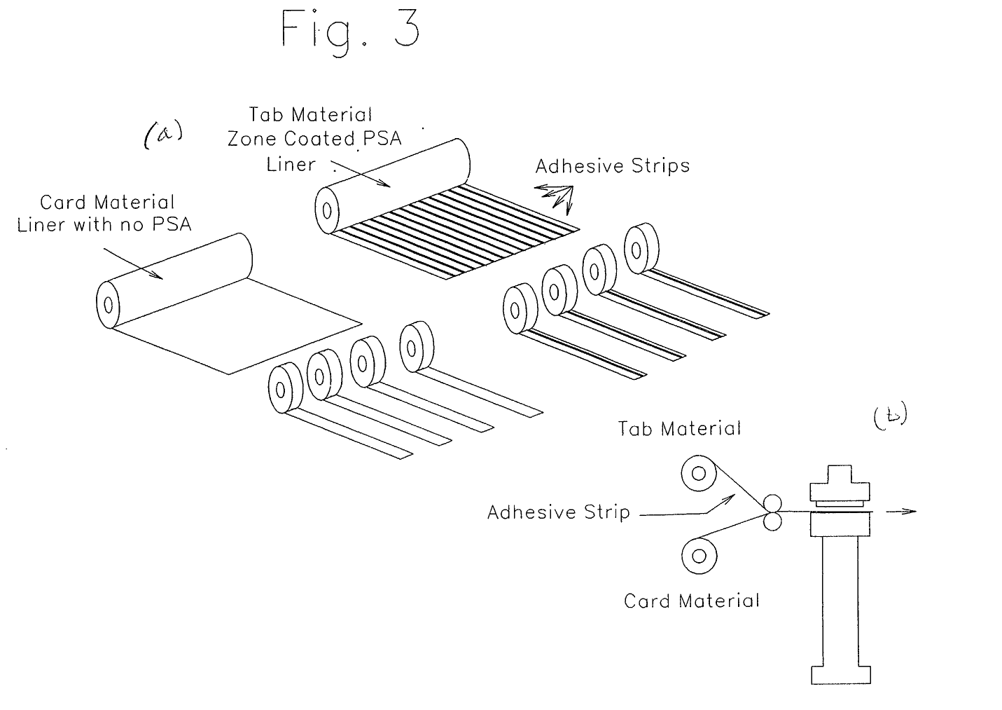

The tab 51 of the present invention is depicted in its various forms in FIGS. 2 and 8, with further details of possible manufacture shown in FIG. 3. As shown therein, tab 51 comprises a tab stem portion 53 having a free length a and an adhesive length b and a width d. Tab 51 also includes a base portion 55 having a width c. The stem width d is preferably about half that of the width of tape 3. Base portion width c is chosen to be wider than slot opening 59 so that a mechanical interference will occur as it comes into contact with it, and for convenience may be even wider to allow for ready handling by a user's hands. Adhesive length b is chosen to ensure that sufficient adhesive power is presented in the amount of adhesive deposited to ensure that the two overlapping layers of tape are securely and reliably held together during use. The more aggressive the adhesive, the smaller amount needed, and the smaller the required adhesive length b. The stem length a is chosen to ensure that the adhesive clears the tension roller 13 before the base portion removes the stem portion 53 therefrom, i.e. thereby shielding adhesive 57 from contacting tension roller 13. The adhesive 57 may comprise one of several alternative constructions as shown in FIGS. 8 a&c. Shown in FIG. 8a is a preferred embodiment wherein a release layer, such as silicone, separates adhesive 57 from the stem portion 53, so that upon separation from stem portion 53 only tab adhesive 57 (or adhesive ) is deposited on tape 3 as will be explained below. In a less preferred embodiment, a paper carrier 90, surrounded by layers of tab adhesive 57 are separated from the tab 51 upon practicing the method of the present invention as explained below. It is contemplated by the inventors that the first alternative is preferable in that less bulk is deposited on the tape, meaning less thickness, and a less complicated final assemblage is created, all of which is thought to result in more successful and reliable operation.

As shown in FIG. 3, a plurality of tabs 51 may be constructed to be carried on a card material liner stock by separately forming rolls of tab material having a zone coated layer of pressure sensitive adhesive, and rolls of liner material, and then passing the two rolls together through a die cutter and former which will stamp out the tabs 51 along a continuous roll of liner. The end product would have the proper layers of release and would be configured to permit a user to lift off a tab to thereby expose a layer of adhesive as shown in either embodiment of FIG. 8a or 8b. While many materials well known to those of skill in the art would suffice, examples are 12 point paper for the liner material, 78# paper for the tab material, silicone as a release layer material, and AP-114 manufactured by Applied Products, Inc. of Machesney Park, Ill. for a water based acrylic adhesive with a thickness in a range of 1 to 2 mil. Further, the release layers should be chosen to ensure that when a tab is separated from its liner, the layer of adhesive follows the tab and doesn't remain on the liner.

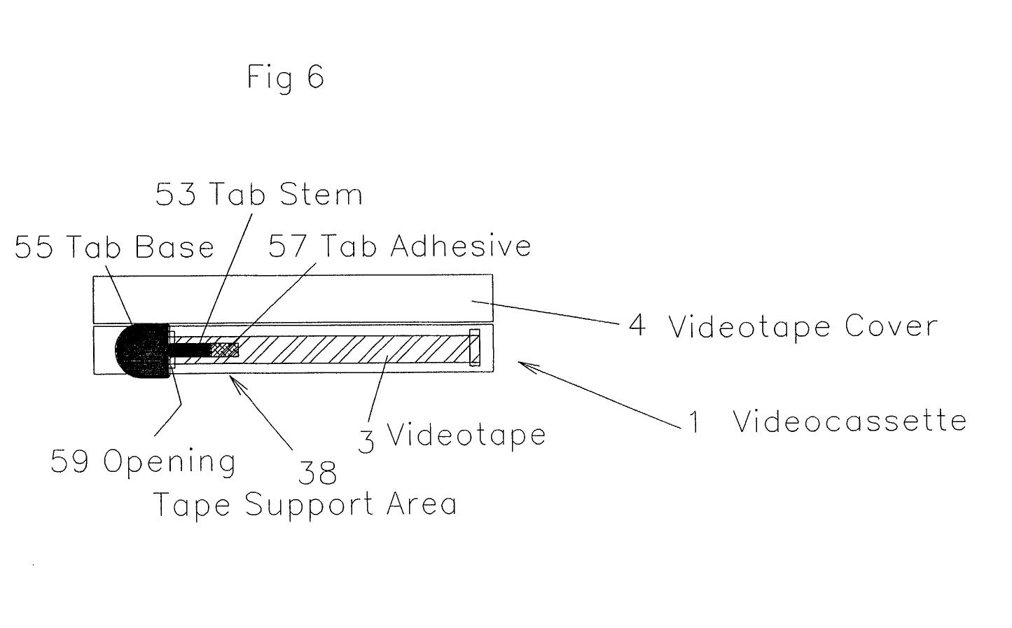

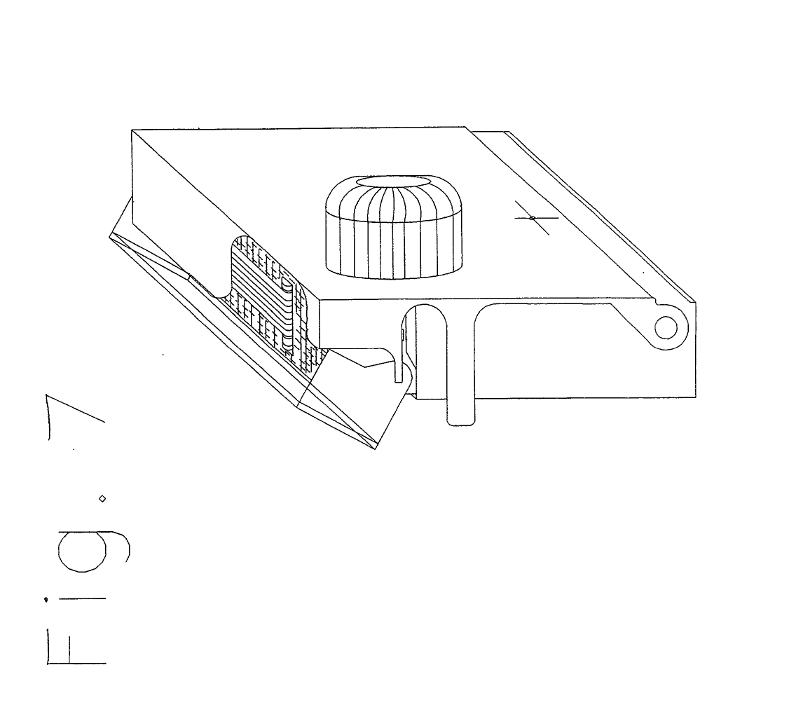

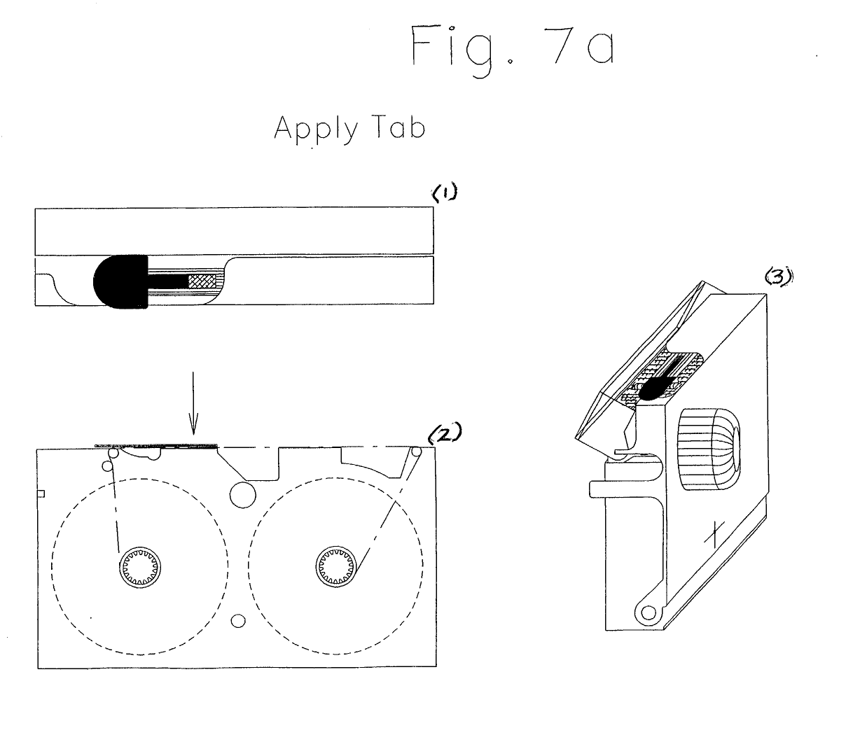

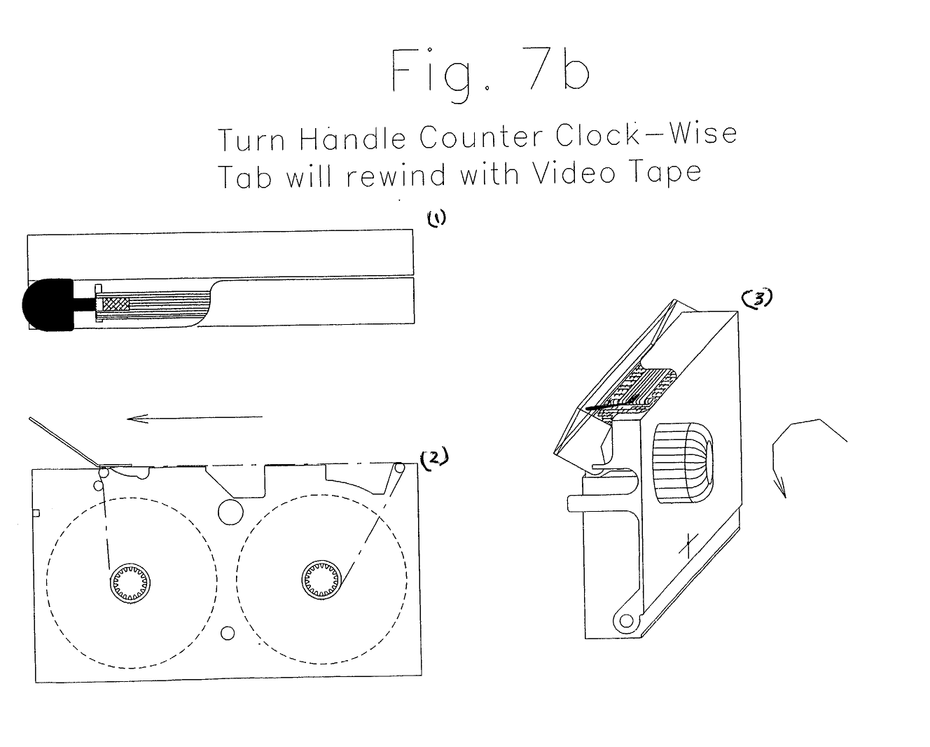

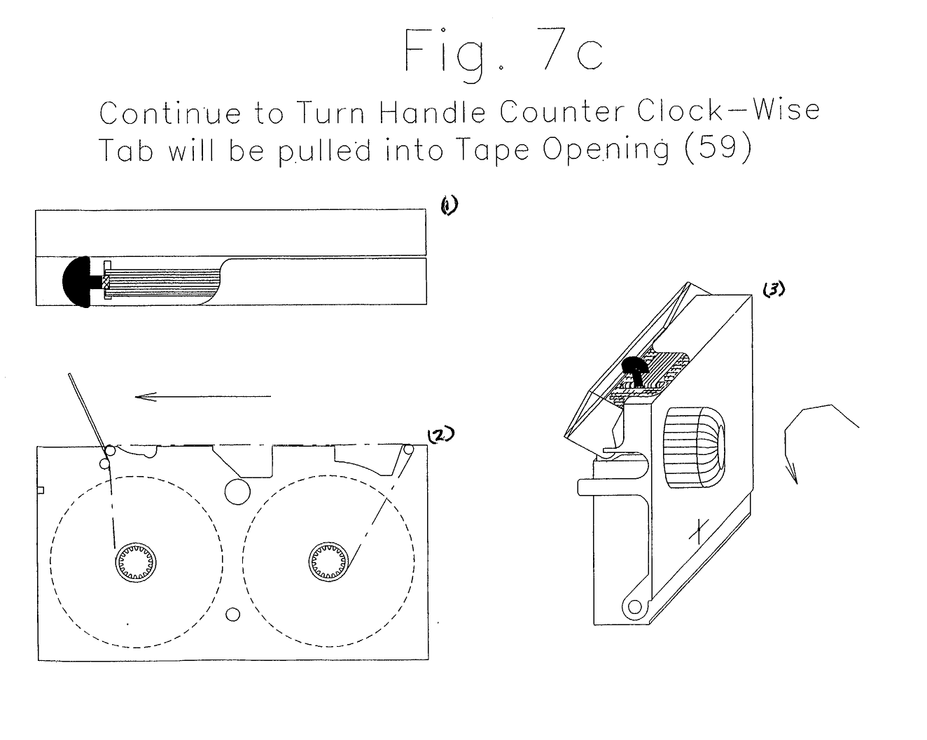

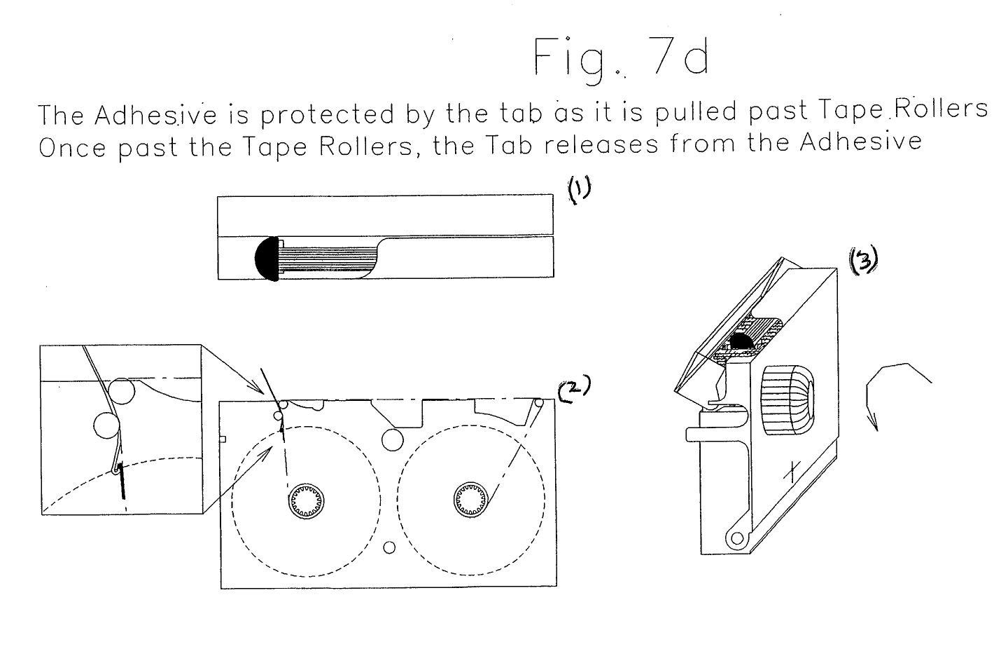

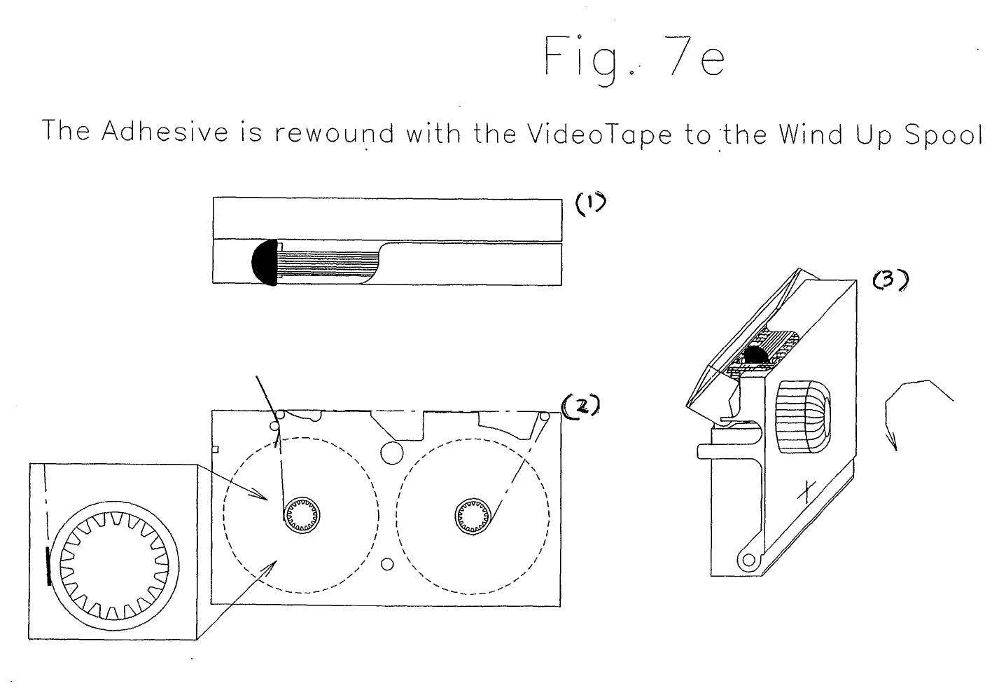

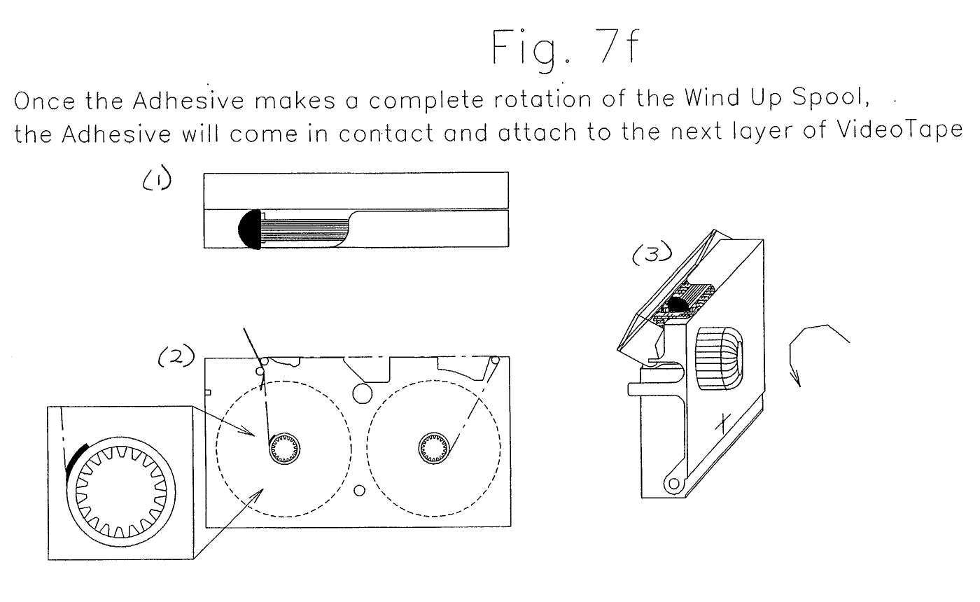

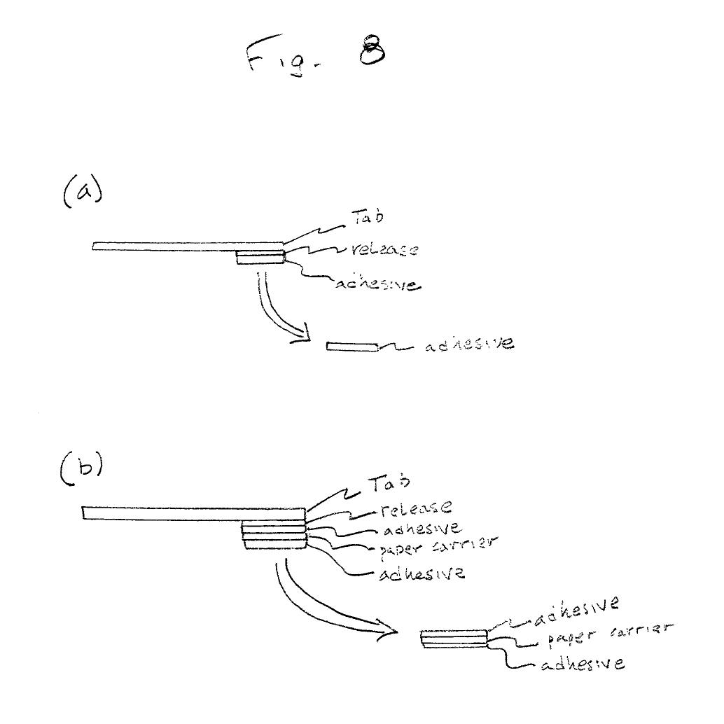

The method of creating a new starting position on a videotape can now be explained by referring to FIGS. 6 and 7a-f. As shown in FIG. 6, a tab has been applied to the tape at the cutout on top of the tape support while the cassette is held in place by the fixture. The tab has been applied with the adhesive positioned at the approximate location of where the videotape stopped after being jockeyed back and forth in a VCR to define the desired new starting point. The base portion is oriented closer to the tape slot. This same positioning is shown in FIG. 7a, noting that the tape support provides a backing area to press against to ensure a secure affixation of the adhesive to the tape. The handle/drive is then turned counter clockwise to advance the tape onto the wind up spool as shown in FIG. 7b where the tab stem is just arriving at the slot. Continuing, the handle/drive is turned to advance the tape into the cassette, bringing the tab stem along with it and adjacent a first tension roller. Further continuing, the handle/drive is turned to advance the tape into the cassette, bringing the tab stem along with it and adjacent and then past a second tension roller. Once the stem is past, as shown in FIG. 7d, the base should begin to mechanically interfere with the tape slot so that it further advancement of the tape begins peeling the stem off from the adhesive. It should be noted that the tab stem has thus performed its duty of separating the adhesive from the second tension roller, which is the last internal roller which would otherwise contact the adhesive side of the tape before being taken up by the wind up spool. This prevents the adhesive from undesirably contacting the tension roller and adhering the tape to it, thereby interfering with the proper operation of the cassette. Eventually, as the tape is continued to be advanced by the handle/driver, the adhesive/tape wraps a first time around the wind up spool (shown as starting this wrap around in FIG. 7e), and then overlaps the adhesive with an overlying layer of tape as shown at the beginning of this over-wrapping in FIG. 7f. This method then attaches the pre-determined new starting location on the tape to the wind up spool so that when the tape is next fully re-wound, the new starting position is presented and the leader material is now tightly wrapped around the wind up spool, never to be seen again.

There are alternative embodiments of tab 51 which are contemplated by the inventors to be capable of working well and performing the same function. One such alternative embodiment includes a tab wherein the stem width d is the same dimension as the base width c, and the tab is somewhat longer in overall length so that a user need only retain a grasp of the tab as the tape is advanced. After the portion of the tab having the adhesive advances past the second roller, and perhaps to a marked position on the tab, a user then need only withdraw the tab to separate it from the adhesive. A further modification to the tab could be to make the tab out of relatively stiff material, and the tab inserted into the cassette to apply the adhesive at a point past the second roller, after which the tab could be withdrawn from the cassette by the user. With this construction, it may not be necessary to advance the tape as the tape tension has been relieved by the mechanical releases and the tab could itself extend all the way into contact with the tape lying adjacent the wind up spool. The tab's stiffness would allow it to press the adhesive onto the tape without breaking, and perhaps with only a limited amount of bending. In this way, the adhesive is applied to the tape at a point past the last tension roller which would otherwise come into contact with the adhesive so that as the tape is wrapped around the wind up spool the succeeding layer of tape is adhered to the underlying layer to thereby create a new start position.

It should be noted that this process is somewhat approximate in that there is a short extra distance, perhaps a couple of inches or the distance between the wind up spool and the exposed tape cutout plus one revolution of tape around the wind up spool, of tape that remains within the cassette and is also removed from viewing. However, this short section of videotape is not meaningful to the typical casual observer of these tapes as it represents a short portion of viewing time. Such viewing time would typically be observed as part of the display of the dark screen time before the movie would start or in display of the title. Furthermore, if desired, a user could be instructed to allow for this when positioning the tape for determining the new start location. However, it is not considered as meaningful in the vast majority of instances.

While the invention has been described in the form of various embodiments, these are to be considered as merely exemplary and illustrative, and not exhaustive. There are various changes and modifications that would be apparent to those of ordinary skill in the art and those changes and modifications are intended to be included herein. For example, various other materials having different relative strengths could be used to form the tab to suit the particular application intended for use. The tab could be relatively flexible or relatively stiff, as described above, and yet work as well in applying the adhesive. The shape of the tab could be changed including the length of the stem, the width of the stem, the width of the base, the relative width of the stem and base, and even the size of the base, within the parameters explained herein. Various other kinds of tape cassettes, having other kinds of mechanical interlocks, could readily be provided for using the teaching of the present disclosure. Examples include audio tapes, etc. Still other internal tension roller arrangements could be accommodated by making adjustments to the size, shape and length of the tab, including perhaps the materials used. And, still other variations would be apparent to those of skill in the art such that the inventors intend that their invention be limited solely by the scope of the claims appended hereto and their legal equivalents.

What is claimed is:

1. A method for changing the starting position of a tape contained within a cassette, the tape having a path through the cassette around at least one tension roller, the method comprising the steps of:
accessing the tape at a location approximately corresponding to a new desired starting position,
applying with a tab an adhesive to the tape at said location,
advancing the tape past said at least one roller, said protective tab interfacing between said at least one roller and the adhesive,
removing said tab, and
continuing to advance said tape until the adhesive affixes to an overlying wrap of said tape, said adhesive adhering to said overlying wrap to thereby affix said two overlapping layers of tape and prevent the tape layers from separating in further use of said tape.

2. The method of claim 1 wherein said tape has each of its ends affixed to a spool within said cassette, and wherein the step of continuing to advance the tape includes wrapping the tape around one of said spools until the overlying layer of tape surrounds and affixes to the adhesive as it is closely adjacent said spool, with the resultant effect that the tape is prevented from unwinding from said spool beyond the location at which the adhesive is affixed to the overlying layer of tape.

3. The method of claim 2 wherein said tab has a base for mechanically interfering with the cassette and wherein the step of removing the tab includes advancing the tape past the point of mechanical interference between the tab base and the cassette so that the tab peels off as the adhesive remains adhered to the tape.

4. The method of claim 3 wherein the step of accessing the tape includes placing the cassette within a fixture, said cassette having at least one mechanical interlock inhibiting free access to said tape and wherein said fixture has a corresponding mechanical release for engaging said at least one interlock.

5. The method of claim 4 wherein said cassette has a slot through which said tape moves as it is advanced, and wherein the tab base has a width greater than the slot, and wherein the step of removing the tab includes the step of advancing the tape past the point at which the tab base contacts the edges of the slot to thereby peel the tab away from the adhesive affixed to the tape.

6. The method of claim 5 wherein the cassette has two mechanical interlocks, one for inhibiting access to a portion of the tape and another for releasing movement of the spools, and wherein the step of placing the cassette within the fixture includes engaging both of said mechanical interlocks.

7. The method of claim 6 wherein said fixture includes an advancing handle, said advancing handle being aligned to engage the spool as the cassette is placed within the fixture and wherein the steps of advancing the tape and continuing to advance the tape each includes rotating the advancing handle.

8. A fixture for receiving a cassette containing a tape, said cassette having at least one mechanical interlock for restricting access to said tape, said fixture having a mechanical release for engaging said at least one mechanical interlock so that when said cassette is engaged by said fixture the tape is accessible.

9. The fixture of claim 8 wherein said cassette includes a mechanical interlock inhibiting the movement of tape within the cassette, and the fixture includes a mechanical release for engaging said movement interlock as the cassette resides within the fixture.

10. The fixture of claim 9 wherein said mechanical release for engaging the movement interlock is positioned to engage its corresponding mechanical interlock automatically as the fixture is closed about the cassette.

11. The fixture of claim 8 wherein said cassette includes a mechanical interlock inhibiting the access to a length of exposed tape from outside the cassette, and the fixture includes a mechanical release for engaging said exposed tape interlock as the cassette resides within the fixture.

12. The fixture of claim 11 wherein said mechanical release for engaging the exposed tape interlock is positioned to engage its corresponding mechanical interlock automatically as the cassette is placed in position within the fixture.

13. The fixture of claim 8 wherein said cassette includes a mechanical interlock inhibiting the movement of tape within the cassette, a mechanical interlock inhibiting the access to a length of exposed tape from outside the cassette, and the fixture includes a mechanical release for engaging each of said movement interlock and said exposed tape interlock as the fixture is closed over the cassette.

14. The fixture of claim 13 further comprising a handle for engaging the cassette and advancing the tape within the cassette, and a drive for driving the tape within the tape in only one direction.

15. The fixture of claim 8 wherein said fixture comprises a receiver portion and a door portion, and further comprising a hinge which joins said portions in clam shell fashion.

16. The fixture of claim 15 wherein said mechanical release in positioned to automatically engage the movement interlock as the fixture is closed about the cassette.

17. The fixture of claim 16 further comprising a handle for engaging the cassette and advancing the tape within the cassette.

18. The fixture of claim 17 further comprising a catch for releasably latching the portions in a closed position about the cassette.

19. A fixture for receiving a cassette containing a tape, said cassette having a pair of mechanical interlocks for restricting free access to said tape, one of said mechanical interlocks inhibiting the movement of tape within said cassette and the other of said mechanical interlocks inhibiting access to an exposed portion of said tape, said fixture having a mechanical release for automatically engaging each of said mechanical interlocks so that when said cassette is placed within the fixture, and the fixture is closed about the cassette, the mechanical interlocks are automatically released and the tape is freely accessible.

20. A tab for affixing an adhesive to a tape which passes by at least one roller within a cassette before said tape is taken up by a spool, said cassette having a slot through which said tape is advanced, said tab having a stem portion of a first width smaller than the slot width, a quantity of releasable adhesive affixed near an end of said stem portion, and a base portion of a second width, the second width being larger than the slot width, and wherein the base portion mechanically interferes with the slot as the tape is advanced within the cassette.

21. The tab of claim 20 wherein said cassette contains more than one roller positioned between an exposed portion of said tape and the spool, and wherein the stem portion length is long enough to mechanically interfere with the slot only after the tape is advanced past the last roller contacting the exposed tape side.

22. The tab of claim 21 wherein said stem portion and said base portion are formed in a layer of paper product and wherein said tab further comprises a release layer interfacing between said layer of paper product and the adhesive.

23. The tab of claim 20 wherein said adhesive includes a carrier.

24. The tab of claim 23 wherein said carrier comprises a piece of paper.

25. The tab of claim 24 wherein said tab comprises a layer of a paper product, and further comprises a release layer interfacing between the adhesive and the layer of paper product.

26. The tab of claim 20 further comprising a liner, and a plurality of tabs releasably adhered to said liner.

27. A tab for affixing an adhesive to a tape and remaining in contact and covering the adhesive as the tab is advanced past at least one roller within a cassette contacting the same side of said tape, said cassette having an external and accessible slot through which said tape is advanced into an interior portion of said cassette, said tab having a stem portion of a first width smaller than the slot width, with a quantity of releasable adhesive affixed near an end of said stem portion, and a base portion of a second width, the second width being larger than the slot width, both of said stem and said base portions being formed of a paper product, with a layer of release positioned between the adhesive and the stem portion, and wherein the stem portion length between the adhesive and the base portion is sufficiently long so that the base portion mechanically interferes with the slot only after the adhesive advances past the last roller contacting the same side as the tape is advanced into the cassette.

28. A method for automatically exposing a portion of tape contained within a cassette, said cassette having at least one mechanical interlock inhibiting free access to said tape, the method comprising the steps of
placing the cassette in a clamshell fixture, said fixture having a mechanical release corresponding to each of said mechanical interlocks, and
closing the clamshell fixture about the cassette to thereby bring each of the mechanical releases into contact with each of their corresponding mechanical interlocks and thereby automatically expose a portion of tape.

29. The method of claim 28 wherein the tape is attached at either end to a spool, said spools engaging a spool interlock, and wherein said cassette has a pair of mechanical interlocks, one of said interlocks comprising a spring loaded cover hinge and the other of said interlocks comprising the spool interlock, and wherein the step of closing the clamshell fixture includes bringing a mechanical release into contact with each of said interlocks.

30. A tab for affixing an adhesive to a tape and remaining in contact and covering the adhesive as the tab is advanced past at least one roller within a cassette contacting the same side of said tape, said cassette having an external and accessible slot through which said tape is advanced into an interior portion of said cassette, said tab having a quantity of releasable adhesive affixed near an end thereof, with a layer of release positioned between the adhesive and the tab, and wherein the tab length between the adhesive and the opposite end is sufficiently long so that the tab remains exposed outside the slot at least until the adhesive after application to the tape advances past the last roller contacting the same side thereof as the tape is advanced into the cassette.

31. The tab of claim 30 wherein the tab is substantially the same width along the entire length of that portion which is intended for insertion within the cassette.

32. The tab of claim 30 wherein said tab is constructed of relatively stiff material allowing for the tab to be inserted into the cassette and past the at least one roller to apply the adhesive to a portion of tape wound around a wind up spool contained within the cassette.

33. A tab for affixing an adhesive to a tape at a point of the tape wound about a wind up spool, the tape being advanced past at least one roller within a cassette contacting the same side of said tape to which said adhesive is applied, said cassette having an external and accessible slot through which said tape is advanced into an interior portion of said cassette, said tab having a quantity of releasable adhesive affixed near an end thereof, with a layer of release positioned between the adhesive and the tab, and wherein the tab length between the adhesive and the opposite end is sufficiently long so that it remains exposed outside the slot as the tab and adhesive is brought into contact with said tape wound about the wind up spool.

34. A tab for affixing an adhesive to a tape which passes by at least one roller within a cassette before said tape is taken up by a spool, said cassette having a slot through which said tape is advanced, said tab having a stem portion of a first width smaller than the slot width, a quantity of releasable adhesive affixed near an end of said stem portion, and a base portion of a second width, the second width being larger than the slot width, and wherein the base portion mechanically interferes with the slot as the tape is advanced within the cassette.

35. A method for changing the starting position of a tape contained within a cassette, the tape having a path through the cassette around at least one tension roller, the method comprising the steps of:
accessing the tape at a location approximately corresponding to a new desired starting position, said tape lying adjacent a wind up spool,
applying with a tab an adhesive to the tape at said location,
withdrawing the tab from within the case, and
advancing said tape until the adhesive affixes to an overlying wrap of said tape, said adhesive adhering to said overlying wrap to thereby affix said two overlapping layers of tape and prevent the tape layers from separating in further use of said tape.

36. The method of claim 35 further comprising the step of releasing the tension on said tape within the cassette.

37. The method of claim 36 further comprising the step of re-applying the tension on said tape within said cassette after said adhesive has been applied and before advancing the tape to affix the adhesive.
